(19) United States
(12) Patent Application Publication
(10) Pub. No.: US 2022/0004984 A1
(43) Pub. Date: Jan. 6, 2022

(54) Industry workflow of distributed manufacturing, incorporating OEM part manufacturing outsourcing, web workflow coupled with real-world workflow integrations and distributed ledger technology functionality.

(71) Applicant: Jeremy Goodwin, San Leandro, CA (US)

(72) Inventor: Jeremiah Goodwin, San Leandro, CA (US)

(73) Assignee: SyncFab Co., San Leandro, CA (US)

(21) Appl. No.: 16/918,571

(22) Filed: Jul. 1, 2020

(51) Int. Cl. G06Q 10/08; G06Q 10/06; G06F 16/182

(52) U.S. Cl. CPC G06Q 10/0875; G06F 16/1834; G06Q 10/06312

(57) ABSTRACT

The supply chain process described herein offers a business-ready original equipment manufacturer (OEM) blockchain supply chain and part procurement platform, with modular ERP value added solutions. This process is designed to resolve a multitude of longstanding inefficiencies for procurement and IT departments in the manufacturing and supply chain process, allowing procurement departments get precision parts faster and cheaper, suppliers to stay busy and profitable, and OEM IT teams to gain a powerful new tool to assist with digital transformation in the part supply chain lifecycle from procurement to recall while procuring from Tier-agnostic suppliers. This process merges the industrial manufacturing industry best practices workflow, to deliver the functionality and benefits of commercialized blockchain technology to large manufacturers and OEMs. The use of a distributed manufacturing workflow with the integration of distributed ledger technology in this process fosters convenience, cost-control, and flexibility for distributed OEM parts manufacturing networks as well as optimized security, supplier verification, supplier smart contract, part authentication and part traceability.

### BACKGROUND OF THE INVENTION

### Field of the Invention

The present invention relates generally to a type of supply-chain workflow process using distributed ledger technology.

### Related Art

The manufacturing supply chain process imposes massive burdens its participants, particularly procurement managers and associated IT departments, including lengthy and costly delays associated with the enterprise resource planning (ERP) qualification process, and inaccurate and uncertain production status updates. Exacerbating these problems is a lack of an effective coordinated effort on the part of all parties, combined with procurement processes that need to move quickly.

Other supply chain processes lack basic transparency. Procurement managers frequently face long delays as part of the ERP qualification process. Time-intensive and costly inefficiencies proliferate, enhancing the risks of miscommunications or other errors, and potentially costing manufacturers millions of dollars in lost revenue, lost procurement opportunities, and damage.

The existing supply chain processes are generally external, opaque, and have siloed data, which limits the ability to effectively source parts. Fewer than half of Chief Procurement Officers have confidence in their team's ability to source. This is a serious problem as 70% of cost savings in supply chains come from finding new suppliers while only 30% is derived from renegotiation. Moreover, the ERP qualification process creates delays that cost buyers and suppliers money. When new suppliers are qualified into an OEM's ERP, long lead times preclude taking advantage of real-time savings opportunities.

IT Departments at OEMs, charged with leading digital transformation, are often hesitant to interfere with procurement processes given the accelerated production schedules involved. This challenge is exacerbated by a disconnected, fragmented supplier base, perpetuating a problem of valuable but inaccessible siloed supplier data. Further, supply chain is the weakest industry link in cybersecurity defense.

This invention allows procurement managers to save money by eliminating long delays associated with ERP qualification. It enables on-time delivery of precision parts that meet or beat budgeted costs, while maintaining full certification compliance, and helps IT departments implement digital transformation initiatives by offering full supplier verification, blockchain-based part and material certification, IP protection, free-flowing data, supply chain traceability at the point of production, and inventory and recall management. In addition, this invention involves the utilization of the “digital trust” and tamper-proof features of distributed ledger technology within the supply chain, which minimizes the risks and costs involved in manufacturing, and eliminates the possibility of duplicative, discordant, or otherwise inefficient elements of the supply chain.

### BRIEF SUMMARY OF THE INVENTION

This invention relies on a specialized supply chain workflow process combined with distributed ledger technology to eliminate the inefficiencies that frequently permeate the manufacturing supply chain.

The manufacturing supply chain process described herein allows for an entire distributed manufacturing workflow process (e.g., from RFQ, to Purchase Order, to smart contract fulfillment, to final order certification) to be combined in a coordinated and efficient set of procedures and quality safeguards.

This process also uses cryptographically-secured distributed ledger technology, improving the efficiency of the supply chain, saving significant time and costs to procurement managers, suppliers, end users, and other supply chain participants. The distributed ledger technology (i.e., blockchain) capabilities described herein allows management of an identity from provisioning through changes in role, access, and administration, and ultimately to de-provisioning.

This invention involves nine main components, listed below:

1) Automated and Rapid RFQs;

2) Blockchain Security and Secure Document Management;

3) Supplier Diversification;

4) Blockchain Incentive Mechanism;

5) RFQ Review and Acceptance;

6) Quality Control & Suppler Verification;

7) On-Time Part Tracking & Fulfillment;

8) On-Time Delivery Validation and Payment; and

9) Automated Exceptions Handling.

The Relationship Between the nine Components is described as follows:

1) Automated and Rapid RFQs:

The manufacturing procurement process described herein is fully automated allows rapid processing of multiple RFQs through and beyond the Tier 1 manufacturing process.

2) Blockchain Security and Secure Document Management

The process described herein involves the use of distributed ledger technology, or blockchain, as well as Secure Document Management to provide security and secure processing of part design blueprint intellectual property (IP) and record of supplier access to part design for purpose of RFQ quotation.

3) Supplier Diversification

Through the use of a supplier network, and real-time notifications, procurement managers are given valuable information supplier availability and can diversify supplier risk through a trustless and automated system.

4) Blockchain Incentive Mechanism

A blockchain-based incentive mechanism accelerates supplier responsiveness for RFQs.

5) RFQ Review and Acceptance

Here, buyer and supplier part RFQs are reviewed and accepted, Purchase Orders are authorized, and part production commences. This step involves use of a relational database enhanced by distributed ledger technology.

6) Quality Control & Suppler Verification

Various procedures are undertaken to ensure and verify supplier quality control and authentication. At this stage, suppliers are vetted thoroughly through verification of supplier certifications, QC questionnaires, and other quality management procedures.

7) On-Time Part Tracking & Fulfillment

A distributed ledger-enabled milestone manager allows production tracking.

8) On-Time Delivery Validation and Payment

Production tracking, in the form of a distributed ledger-enabled milestone manager, allows buyer and supplier automated email updates of production status.

9) Automated Exceptions Handling

In instances where parts are found to be non-compliant parts, automated NCR exception remedies are applied, with use of relational database APIs, and enhanced by blockchain-based smart contracts where applicable.

### BRIEF DESCRIPTION OF THE DRAWINGS

FIG. 1. The workflow diagram follows the relevant stages of the supply chain lifecycle and reflects the coordination of relevant parties, processes and procedures throughout the distributed manufacturing supply chain process, incorporating each of the nine key steps and features of the invention.

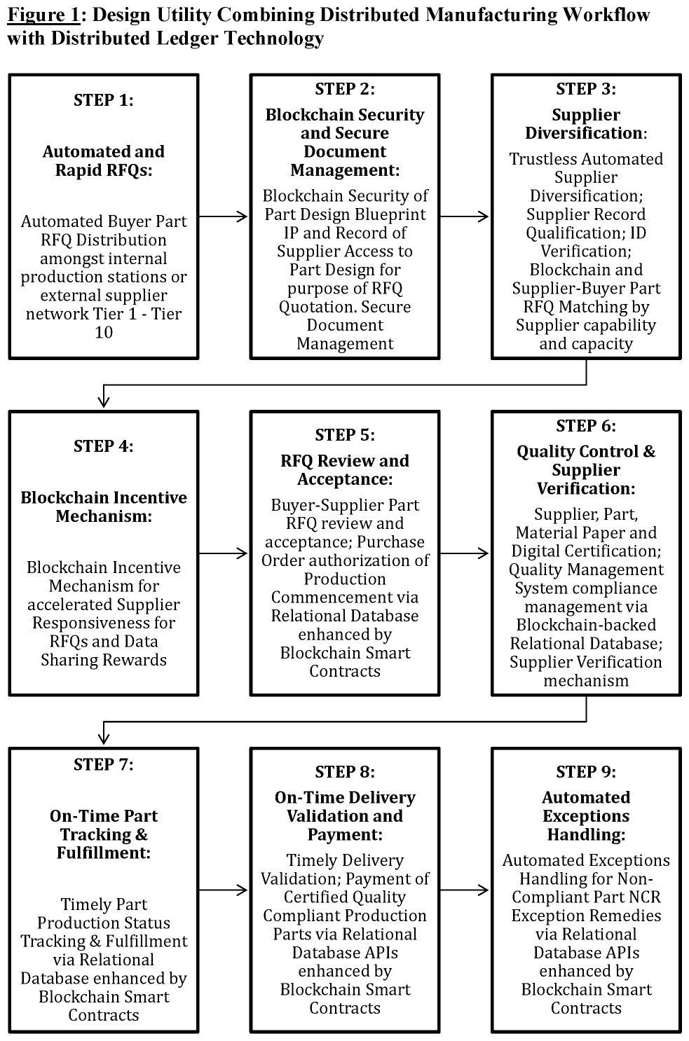

FIG. 2. This illustration demonstrates the application of the supplier verification process (Step 6) as a platform-based solution for procurement managers. The illustration shows the supplier verification platform in the context of each digital element of the procurement user interface, including web app sign-in, use of AWS Cloud hosting, integration with a unique blockchain identity, and each applicable application programming interface (API).

### DETAILED DESCRIPTION OF THE INVENTION

1. Automated and Rapid RFQs: The process involved in the instant invention begins during the manufacturing procurement process. Procurement Departments must often have multiple part RFQs to justify a purchase order, and this process allows the process to be automated, saving costs and thousands of man hours as compared to manual part RFQs. The process includes automation of supplier payments; confirmation of the quantity of authentic parts; invoice reconciliation; funding confirmation; payment authorization; and automated deadlines for suppliers to accept payment terms of the OEMs. This capability is combined with each part having a unique distributed ledger identity. This automation continues beyond the Tier 1 manufacturing process, to internal production stations or external supplier networks in Tier 1-Tier 10.

2. Blockchain Security and Secure Document Management: The process described herein involves the use of distributed ledger technology, or blockchain, as well as secure document management to provide security and secure processing of part design blueprint intellectual property (IP) and record of supplier access to part design for purpose of RFQ quotation.

This process includes secure document management via cryptographic or other means, enabling platform security and organization of documents, multi-team seat access to secured documents, and manufacturing part history using the digital trust factor of distributed ledger technology and OCR technology for automatic scanning of documents and verification of contents. This document management process customizes and manages documents according to type (i.e., certification, audit report, quality certification, etc.)

3. Supplier Diversification: This stage of the process utilizes the breadth and depth of a supplier network, along with access to real-time notification of supplier availability. Here, qualification of supplier records, along with ID verification take place on the blockchain, and supplier capability and capacity availability information are made accessible and available via a relational database enhanced by blockchain technology. This allows for a dynamic supply chain process as it provides valuable information about which suppliers are busy and which are not. Moreover, this also enables trustless and automated supplier risk diversification in instances of supply chain disruptions.

4. Blockchain Incentive Mechanism: For accelerated supplier responsiveness for RFQs, this process involves a blockchain incentive mechanism. This step includes rewards (Data Sharing Rewards) and blockchain-based incentives to encourage quick and effective RFQ responsiveness.

5. RFQ Review and Acceptance: At this stage, buyer and supplier part RFQs are reviewed and accepted. Purchase Orders are thereby authorized, and part production commences. The foregoing is accomplished through utilization of a relational database enhanced by blockchain-based smart contracts where applicable.

6. Quality Control & Suppler Verification: To ensure quality in the supply chain, this process tracks, facilitates and communicates the multi-tier supplier quality control (QC) process for OEMs and big brand manufacturers with increasing degrees of blockchain authentication integration at each point as network activity grows. OEMs, which require suppliers to provide quality data on the parts they produce, are able to increase trust in the data as it is verified at source (for instance, data collected from sensors in the factory), and not tampered with in future. This includes QC department Coordinate-measuring machine (CMM), parts inspection photos in the production line with tags of the pass-fail parts, and a machine shop checklist with documentation for QC audit and compliance.

In addition, at this stage in the process, suppliers are vetted through verification of supplier certifications, QC questionnaires, and other quality management procedures. This provides a uniform and dependable certification verification procedure for parts that require them, which is frequently a big problem for prototype and tier 2, 3, 4 suppliers.

Supplier, Part and Material Paper and Digital Certification and Quality Management System (QMS) compliance management via Relational Database enhanced by Blockchain Smart Contracts where applicable.

Supplier Verification takes place via assignment of a unique identity, use of supplier-specific-details, and authenticity and transparency mechanisms as described below:
(a) Supplier Unique Identity—Every Supplier in the Supply chain ecosystem will be assigned a unique digital Blockchain based token that can be used as its Identity in on the Blockchain network for verification and on boarding process.
(b) Supplier Information—The Identity token will include Supplier specific details relating to the its provenance, governance, compliance, business and other related information which is required to manage supplier identity
(c) Authenticity and Transparency—This process will bring transparency and authenticity of the supplier information to stakeholders in the supply chain. There will be a Single trusted source of digital identity for suppliers

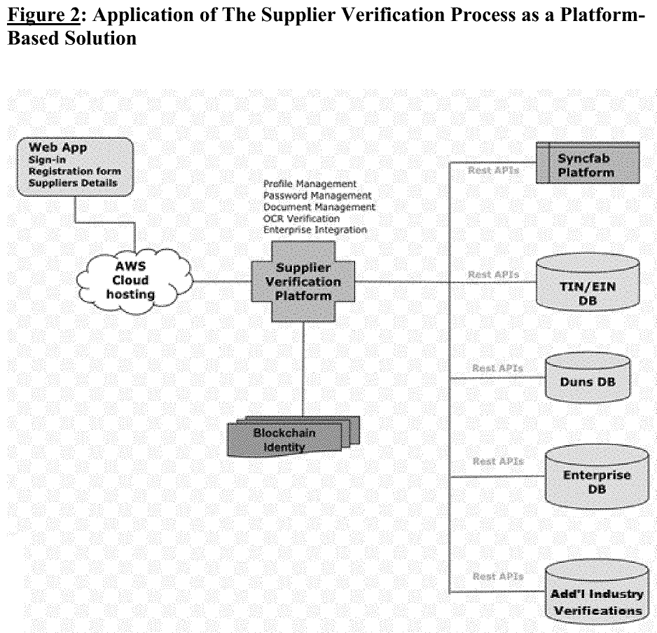

An illustration of the application of the foregoing supplier verification process as a platform-based solution for procurement managers is presented in FIG. 2.

7. On-Time Part Tracking & Fulfillment: This process involves production tracking in the form of a distributed ledger-enabled milestone manager, which allows buyer and supplier automated email updates of production status. This enables Procurement Departments to engage in proactive supply chain management and get accurate production status updates and timely part production status tracking & fulfillment via a relational database enhanced by blockchain smart contracts where applicable to help ensure on-time delivery and transparency.

8. On-Time Delivery Validation and Payment: This stage involves timely delivery validation and payment of certified quality compliant production parts via relational database APIs enhanced by blockchain smart contracts where applicable.

9. Automated Exceptions Handling: In this stage of the manufacturing procurement process, non-compliant parts (generating Non-Compliance Reports (NCRs)) are handled using automated NCR exception remedies via relational database APIs, enhanced by blockchain-based smart contracts where applicable.

At the end of the process, procurement managers will save money by eliminating long delays associated with ERP qualification, have greater supply chain visibility through a supplier network, and be able to ensure on-time delivery of precision parts that meet or beat budgeted costs while maintaining full certification compliance. IT Departments at OEMs are involved with the procurement processes, even given the accelerated production schedules involved, and the supplier base and associated data are accessible.

Successful Implementation: By following the above-listed process, in the order listed, manufacturing industry participants may undergo a distributed manufacturing workflow, with both a web-based and real-world workflow integrations with distributed ledger technology functionality. As a result, and among other efficiencies obtained, procurement managers may undergo the ERP qualification process with no or limited interruptions, inefficiencies, and delays. In addition, self-service management of standard and custom user profile attributes with multi-lingual UI support will be possible. The process entails the definition and management of standard and custom roles, privileges, and assigning roles to users with synchronization to external systems.

The above must be performed in its entirety for the means disclosed here to succeed. However, in cases where there are not any non-compliant parts, Step 9 is not necessary.

The distributed manufacturing workflow described herein could potentially be re-purposed for different supply chain processes, internal manufacturing procurement processes, or for other purposes that differ from their original intended use.

In the manner described above, the instant process may be used in a potentially unlimited number of distributed manufacturing workflow.

What is claimed is:

1. A distributed manufacturing process that combines web and real-world supply chain workflows with distributed ledger technology as shown and described herein.
